(19) United States
(12) Patent Application Publication
(10) Pub. No.: US 2012/0243718 A1
(43) Pub. Date: Sep. 27, 2012

(54) SPEAKER BASE DEVICE FOR DISPLAY

(76) Inventors: Yueh-Hua HSU HUANG, New Taipei City (TW); Wen-Chuan HSU, New Taipei City (TW)

(21) Appl. No.: 13/105,160

(22) Filed: May 11, 2011

(30) Foreign Application Priority Data
Mar. 24, 2011 (TW) 100110171

(51) Int. Cl. H04R 1/02

(52) U.S. Cl. 381/333

(57) ABSTRACT

A speaker base device for display comprises: a base, which internal has at least one PCB, the base extends outwardly to form at least one set of speaker-like structure; and a support column section, which extends upwardly from the base and connects with a display, the external cables of the display pass through an accommodating room of the support column section and electrically connect with the PCB of the base, so that the display can sound through the set of speaker-like structure of the base, and hence prior sounding structure mounted on the display can be replaced for better sound performance.

The current application is a nonprovisional application and claims a priority to the Taiwan application serial number 100110171 filed on Mar. 24, 2011.

### BACKGROUND OF THE INVENTION

1. Field of the Invention

The present invention generally relates to a speaker base device for display, more particularly to a base that is support a display. The base has the function of audio and enable to form a multi-function media player through the connection of the base and external devices.

2. Description of the Prior Art

Design of a speaker cabinet may tremendously affect the speaker general efficiency and timbre sound performance of speakers. On the other hand, according to usage, the structures of speaker cabinet may be totally different. For present displays, mostly, there are two spaces designed at two sides of the display for accommodating speakers. Such arrangement is often too simple (normally better bass performance is not paid off), thus the sound performance will be a lack of features. Further, slim display is more popular, and the internal space for speakers is naturally decreased so as to cause limitations of sound performance.

Some users for better performance can only purchase external speakers, which are vertically attached to two sides of display. Hence an enough space shall be made to accommodate a display and speakers simultaneously. Self-adjusting speaker positions is a need to reach best performance. Accordingly, for better sound performance, lots of additional expenses and space will be made. Thus, it has certain difficulty to most of users, and it seems some of them have no choice to accept the sound performance of the display with internal speakers.

For this reason, if a speaker base device for display is provided, and through a base of the radio base device for supporting display, the base has the function of audio in order to replace prior internal speakers of display and save room for extra speaker. That will be a best solution.

### SUMMARY OF THE INVENTION

The main objective of the present invention is to provide a speaker base device for display. Through a base for supporting display, the base has the function of audio in order to replace prior internal speaker of display and save room for extra speaker.

The second objective of the present invention is to provide the speaker base device for display. The structure of the present invention is assembled in an easiest way to approach a better bass performance of subwoofer.

To approach above objectives of the speaker base device for display, the base device comprises: a base, which internal has at least one PCB, the base extends outwardly to form at least one set of speaker-like structure; and a support column section, which extends upwardly from the base and connects with a display, the external cables of the display pass through an accommodating room of the support column section and electrically connect with the PCB of the base, so that the display can sound through the set of speaker-like structure of the base, and hence prior sounding structure mounted on the display can be replaced for better performance.

Preferably, the display is an LED TV.

Preferably, the display is an LCD TV.

Preferably, the display is a computer display.

Preferably, the base of the speaker base device is added a DVD player.

Preferably, the base of the speaker base device is added at least one connecting interface.

Preferably, the connecting interface is a USB interface.

Preferably, the connecting interface is memory card entrance.

Preferably, the connecting interface is an electronic device adapter port.

Preferably, if more than one set speaker-like structures, at least one set of speaker structure is a subwoofer speaker-like structure.

Preferably, the one (or more than one) sets of speaker-like structures are to form a 2.0-channel structure.

Preferably, the one (or more than one) sets of speaker-like structures are to form a 2.1-channel structure.

Preferably, the base of the speaker base device is added a wireless dongle.

Preferably, the base of the speaker base device is added a extra wireless speaker, and the wireless speaker and the two (or more than one) sets of speaker structures are to form a 5.1-channel structure.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1A illustrates a schematic 3-D front view of a first preferred embodiment of the present invention;

FIG. 1B illustrates a schematic 3-D rear view of the first preferred embodiment of the present invention;

FIG. 2A illustrates a schematic front view of the first preferred embodiment of the present invention;

FIG. 2B illustrates a schematic rear view of the first preferred embodiment of the present invention;

FIG. 3A illustrates a schematic left view of the first preferred embodiment of the present invention;

FIG. 3B illustrates a schematic right view of the first preferred embodiment of the present invention;

FIG. 4 illustrates a schematic top view of the first preferred embodiment of the present invention;

FIG. 5 illustrates a schematic 3-D front view of a second preferred embodiment of the present invention,

FIG. 6 illustrates a illustrates a schematic left view of the second preferred embodiment of the present invention, and

FIG. 7 illustrates a schematic top view of the second preferred embodiment of the present invention.

### DETAILED DESCRIPTION OF THE INVENTION

Following preferred embodiments and figures will be described in detail so as to achieve aforesaid objects.

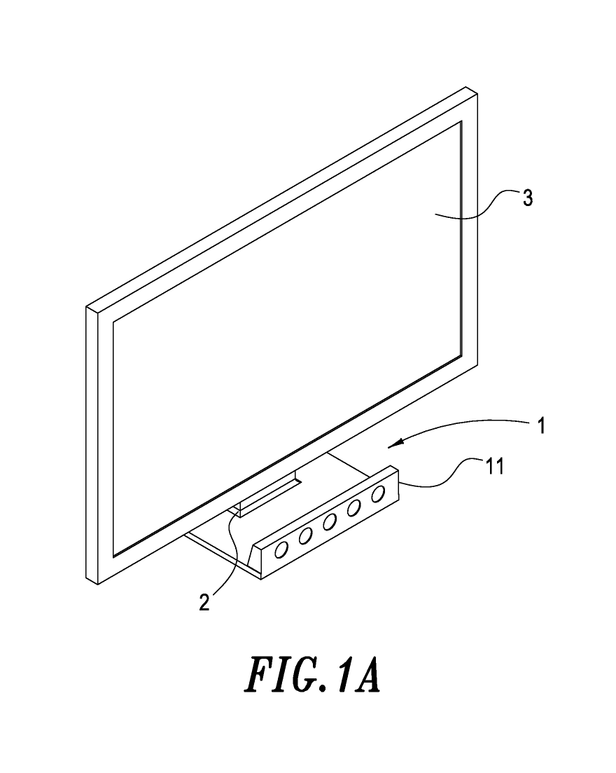

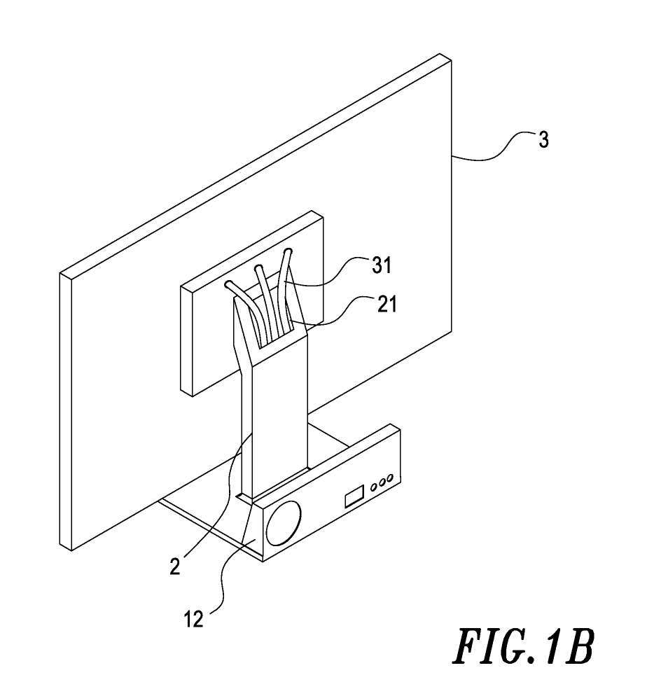

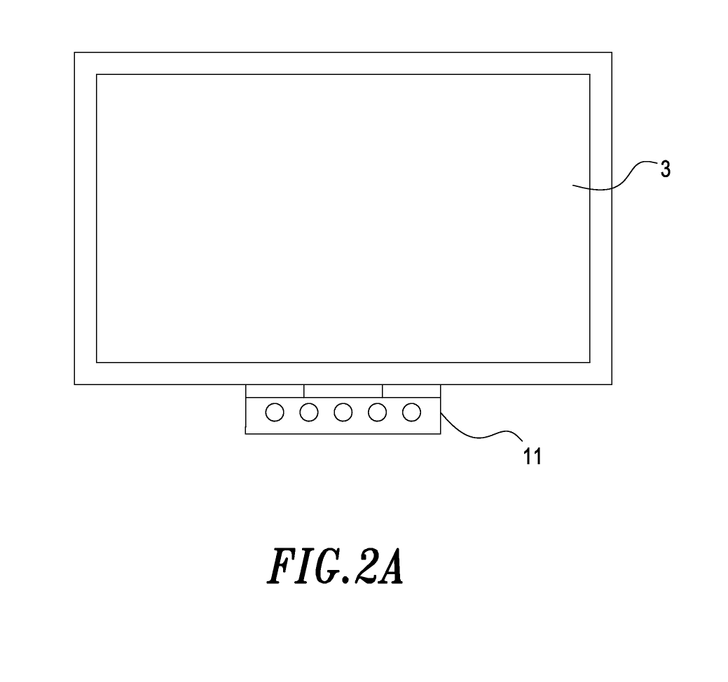

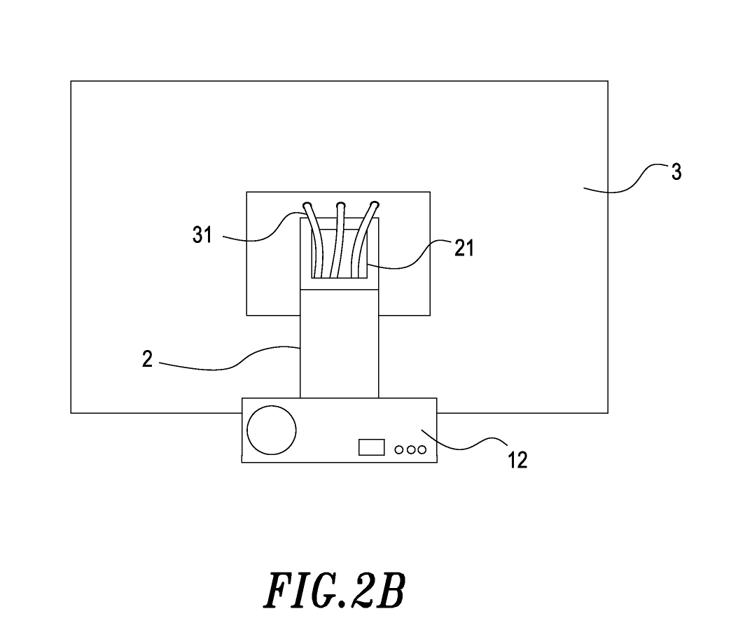

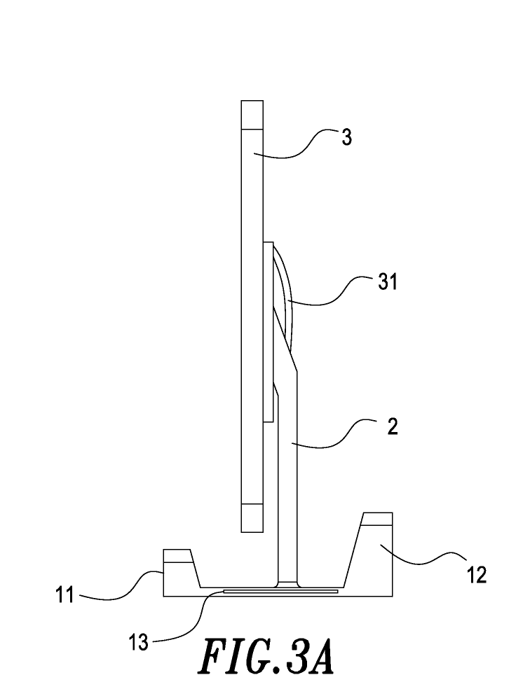

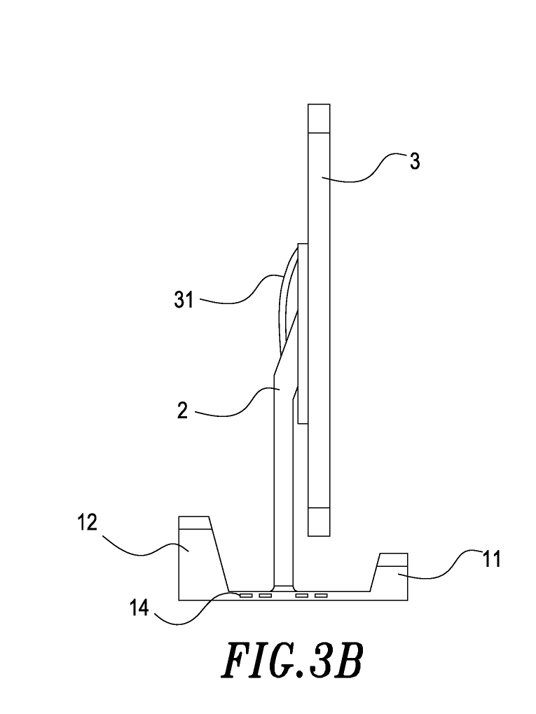

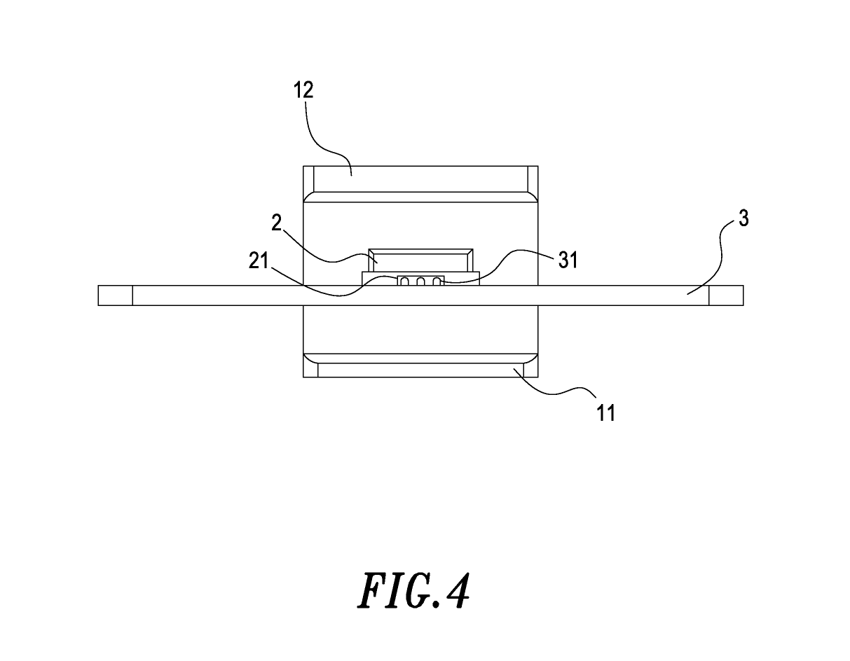

With references to FIG. 1A, FIG. 1B, FIG. 2A, FIG. 2B, FIG. 3A, FIG. 3B, and FIG. 4, which illustrate a schematic 3-D front view of a first preferred embodiment of the present invention, a schematic 3-D rear view of the first preferred embodiment of the present invention, a schematic front view of the first preferred embodiment of the present invention, a schematic rear view of the first preferred embodiment of the present invention, a schematic rear view of the first preferred embodiment of the present invention, a schematic left view of the first preferred embodiment of the present invention, a schematic right view of the first preferred embodiment of the present invention, and a schematic top view of the first preferred embodiment of the present invention. As shown in figures, a speaker base device for display includes: a base 1, the internal of the base 1 has at least one PCB, the base 1 extends forwardly and backwardly to form two sets of speaker structures 11, 12 with at least one speaker (For the best mode, at least one set of speaker structure); and a support column section 2, which extends upwardly from the base 1 and connects with a display 3, the external 31 of the display 3 pass through an accommodating room 21 of the support column section 2 and electrically connect with the PCB of the base 1, so that the display 3 can sound through the two sets of speaker-like structures 11, 12 of the base 1.

There is one thing to be noted, the accommodating room 21 of the support column section 2 is to accommodate the external cables 31 connecting with the display 3 and the base 1, so that the exposure of the external cables 31 can avoid for good-looking appearance.

Preferably, the set of speaker structure 11 has at least one speaker.

Preferably, the set of speaker-like structure 12 has at least one speaker.

Preferably, the display 3 is an LED TV.

Preferably, the display 3 is an LCD TV.

Preferably, the display 3 is a computer display.

Preferably, the base 1 of the speaker base device is added a DVD player.

Preferably, the base 1 of the speaker base device is added at least one connecting interface 14 in order to receive video signals and audio signals. By means of the external cables 31 connecting with the display 3, the video signals are shown on the display 3 and the audio signals are delivered to the two sets of the speaker-like structures 11, 12.

Preferably, the connecting interface 14 is a USB port.

Preferably, the connecting interface 14 is memory card entrance.

Preferably, the connecting interface 15 is an electronic device adapter port, such as mobile phone or player.

Preferably, the two sets of speaker structures 11, 12 may have an elevation angle individually in order to let audiences be easily received.

Preferably, one of the two sets of speaker-like structures 11 and 12, is a subwoofer speaker-like structure.

Preferably, the two sets of speaker-like structures 11, 12 are a left speaker and a right speaker so as to form a 2.0-channel structure.

Preferably, the two sets of speaker-like structures 11, 12 are a left speaker, a right speaker and a middle bass subwoofer, so as to form a 2.1-channel structure.

Preferably, the base of the speaker base device is added a wireless dongle for wirelessly broadcasting and playing. A wireless rear speaker added to the speaker base device and the two sets of speaker structures a left speaker, a right speaker, a middle subwoofer speaker, and two rear surrounding wireless rear speakers so as to form a 5.1-channel structure through the wireless dongle.

Preferably, the base 1 can be another embodiment, that is, the base 1 extends outwardly to form at least one set of speaker-like structure.

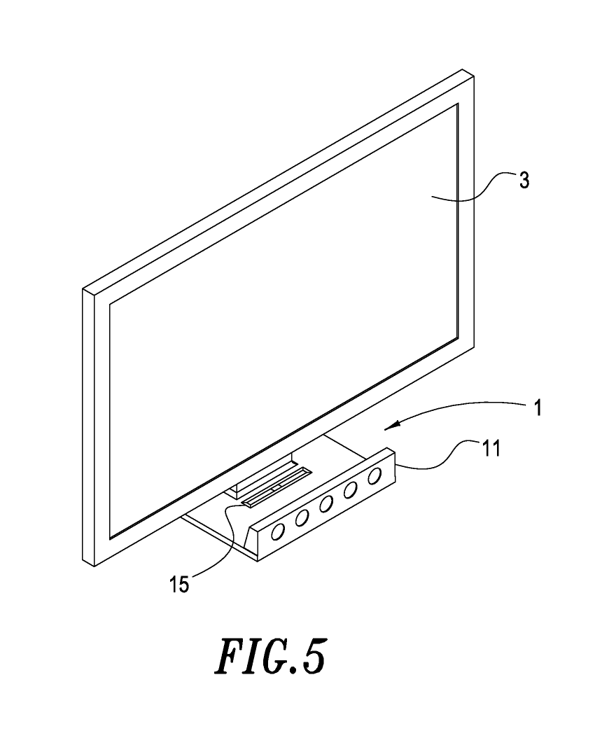

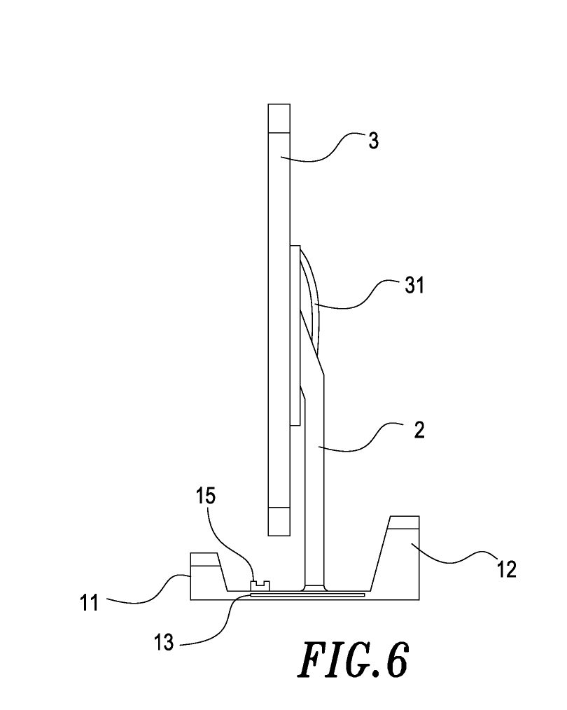

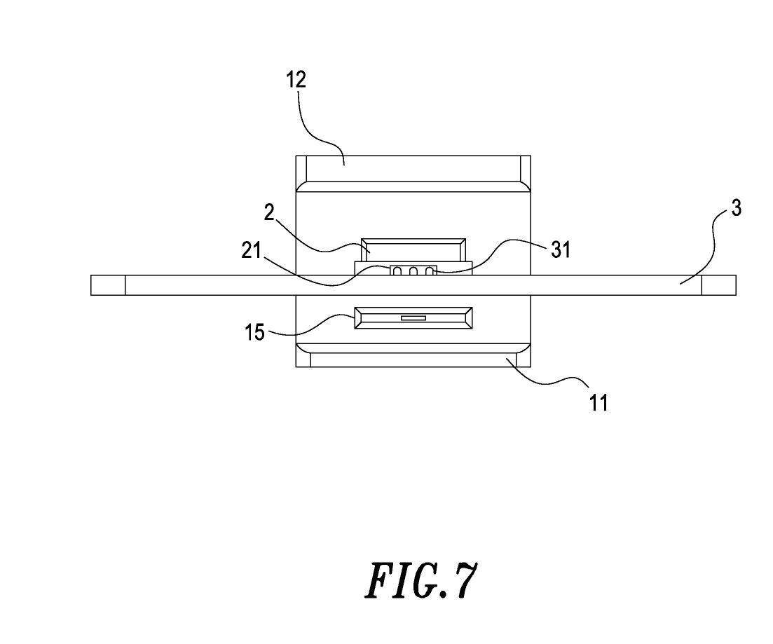

With references to FIG. 5, FIG. 6, and FIG. 7, which illustrate a schematic 3-D front view of a second preferred embodiment of the present invention, a schematic left view of the second preferred embodiment of the present invention, and a schematic top view of the second preferred embodiment of the present invention. As shown in figures, the difference between the two embodiments is that a connecting interface (iPod/iPhone dock) 15 is added to the base, hence an electronic device can be inserted in the connecting interface for receiving and playing the video signals and audio signals of the electronic device.

Comparison with other prior arts, the speaker base device for display provide by the present invention has following advantages listed below:
1. Through a base for supporting display, the base has the function of audio in order to replace prior art with internal speaker and save room for speaker. Thus, the structure of the present invention is assembled in an easiest way to approach a better sound performance and bass performance.
2. The subwoofer speaker structure is designed in the base, where the location of the subwoofer speaker-like structure is suitable in addition to the better performance of bass. Hence, user may not need to adjust the direction and position of the subwoofer speaker structure over and over.
3. The positions of the speaker structures, the base, and the display are corresponding to each other so as to be more visually consistent.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A speaker base device for display comprising:
a base, the internal of the base has at least one PCB, the base extending outwardly to form at least one set of speaker-like structure; and
a support column section, which extends upwardly from the base and connects with a display, the external cables of the display passing through an accommodating room of the support column section and electrically connecting with the PCB of the base, so that the display can sound through the set of speaker-like structure of the base.

2. The speaker base device for display according to claim 1, wherein the set of speaker-like structure has at least one speaker.

3. The speaker base device for display according to claim 1, wherein the display is an LED TV.

4. The speaker base device for display according to claim 1, wherein the display is an LCD TV.

5. The speaker base device for display according to claim 1, wherein the display is a computer display.

6. The speaker base device for display according to claim 1, wherein the base device is added a DVD player.

7. The speaker base device for display according to claim 1, wherein the base device is added at least one connecting interface.

8. The speaker base device for display according to claim 7, wherein the connecting interface is a USB interface.

9. The speaker base device for display according to claim 7, wherein the connecting interface is memory card entrance.

10. The speaker base device for display according to claim 7, wherein the connecting interface is an electronic device adapter port.

11. A speaker base device for display comprising:
a base, the internal of the base has at least one PCB, the base extending outwardly to form two sets of speaker-like structures;
a support column section, which extends upwardly from the base and connects with a display, the external cables of the display passing through an accommodating room of the support column section and electrically connecting with the PCB of the base, so that the display can sound through the speaker-like structure of the base.

12. The speaker base device for display according to claim 11, wherein the speaker-like structure has at least one speaker.

13. The speaker base device for display according to claim 11, wherein the display is an LED TV.

14. The speaker base device for display according to claim 11, wherein the display is an LCD TV.

15. The speaker base device for display according to claim 11, wherein the display is a computer display.

16. The speaker base device for display according to claim 11, wherein one of the two sets of speaker-like structures is a subwoofer speaker-like structure.

17. The speaker base device for display according to claim 11, wherein the two sets of speaker-like structures are assembled to form a 2.0-channel structure.

18. The speaker base device for display according to claim 11, wherein the two sets of speaker-like structures are assembled to form a 2.1-channel structure.

19. The speaker base device for display according to claim 11, wherein the base device is added a wireless dongle.

20. The speaker base device for display according to claim 19, wherein a wireless rear speaker and the two sets of speaker-like structures are assembled to form a 5.1-channel structure through the wireless dongle.

21. The speaker base device for display according to claim 11, wherein the base device is added a DVD player.

22. The speaker base device for display according to claim 11, wherein the base device is added at least one connecting interface.

23. The speaker base device for display according to claim 22, wherein the connecting interface is a USB interface.

24. The speaker base device for display according to claim 22, wherein the connecting interface is memory card entrance.

25. The speaker base device for display according to claim 22, wherein the connecting interface is an electronic device adapter port.
